(19) United States
(12) Patent Application Publication
(10) Pub. No.: US 2015/0317001 A1
(43) Pub. Date: Nov. 5, 2015

(54) PRESSURE SENSOR FOR A STYLUS

(71) Applicant: Microsoft Technology Licensing, LLC, Redmond, WA (US)

(72) Inventors: Dan BEN-BASSAT, Ganei-Tikva (IL); Amit SCHWITZER, Herzlia (IL); Yuval STERN, Even-Yehuda (IL); Shai ROGEL, Kibbutz Gvat (IL)

(21) Appl. No.: 14/702,726

(22) Filed: May 3, 2015

Related U.S. Application Data
(60) Provisional application No. 61/988,241, filed on May 4, 2014.

(51) Int. Cl. G06F 3/0354; G06F 3/044; G06F 3/041

(52) U.S. Cl. CPC G06F 3/03545; G06F 3/0414; G06F 3/044

(57) ABSTRACT

A pressures sensor for sensing pressure on a tip of a stylus includes a variable capacitor, a power supply, and a capacitance measuring unit. The variable capacitor includes a first electrode coated with solid dielectric layer, a second electrode formed at least in part with elastic material, and a support element that moves together with the tip of the stylus and presses against the second electrode in response to pressure applied on the tip. A portion of the dielectric layer is patterned with a conductive pad that is exposed and the second electrode contacts the conductive pad patterned on the dielectric layer. The power supply and the capacitance measuring unit establish electrical connection with the second electrode via the conductive pad.

### RELATED APPLICATION

This application claims the benefit of priority under 35 USC 119(e) of U.S. Provisional Patent Application No. 61/988,241 filed May 4, 2014, the contents of which are incorporated herein by reference in their entirety.

### FIELD AND BACKGROUND OF THE INVENTION

The present invention, in some embodiments thereof, relates to a pressure sensitive stylus and, more particularly, but not exclusively, to a sensor for a stylus that senses transition between a hover and touch state of its tip.

Styluses are known in the art for use with digitizer systems such as with digitizer systems that are integrated with display screens, e.g. touch screens. Stylus position is sensed by a digitizer system and used to provide input to a computing device associated with a display screen. Position of the stylus is typically correlated with virtual information displayed on the display screen. Inputs originating from the stylus are typically interpreted as user commands or user inputs for commands. Typically, a signal emitted by the stylus is detected by the digitizer system both while a writing tip of the stylus is touching and hovering over the display screen. Typically, while touching the display screen, the stylus is used to provide input for altering the content displayed and while hovering over the display screen, the stylus is used as a pointer and/or cursor.

U.S. Pat. No. 6,853,369 entitled “Variable Capacity Condenser and Pointer,” the contents of which are incorporated herein by reference, describes a stylus including a variable capacity condenser that varies with pressure applied on a tip of the stylus. The variable capacity condenser includes a dielectric substance, two electrodes, and a flexible electrode. The dielectric substance has two end faces. The two electrodes are disposed on one end face of the dielectric substance and the flexible electrode faces the other end face of the dielectric substance. A pressing member presses the flexible electrode of the variable capacity condenser to vary a distance between at least a portion of the flexible electrode and the other end face of the dielectric substance.

U.S. Pat. No. 8,536,471 entitled “Pressure Sensitive Stylus for a Digitizer,” assigned to N-Trig Ltd., the contents of which are incorporated herein by reference, describes a pressure sensitive stylus with a movable tip that recedes within a housing of the stylus in response to user applied contact pressure and an optical sensor enclosed within the housing for optically sensing the displacement of the tip and for providing output in response to the sensing. There is also described a capacitive to based displacement sensor including a variable capacitor with one conductive plate in physical communication with stylus tip so that it moves in accordance with the stylus tip movement.

U.S. Patent Application Publication No. 2008/0128180 entitled “Position Detecting System and Apparatuses and Methods for Use and Control Thereof” assigned to N-Trig Ltd., the contents of which is incorporated herein by reference, describes an electromagnetic stylus that emits signals at an oscillation frequency that can be picked up by a digitizer sensor and used to determine its position on the sensor. The stylus includes a variable element, e.g. a resistor, capacitor, or an inductor, that is responsive to pressure exerted on the stylus tip by the user and triggers changes in the frequency emitted by the stylus. The digitizer system is operable to discern between different frequencies emitted by the stylus to determine a position of the stylus and a pressure exerted on the stylus tip by the user.

International Patent Application Publication No. WO2013/160887 entitled “Pressure Sensitive Stylus for a Digitizer,” assigned to N-Trig Ltd., the contents of which are incorporated herein by reference, describes a pressure sensitive stylus including a writing tip that is movable in response to contact pressure applied on the writing tip. An elastomer element is positioned between a surface that moves with the writing tip and a surface formed from a housing of the stylus and compresses in response to contact pressure applied on the stylus tip. Optionally, the elastomer includes a surface with base portion and at least one protrusion extending out from the base portion. When operating the stylus, the at least one protrusion contacts a facing surface over a first range of contact pressures and both the at least one protrusion and the base portion contacts the facing surface for pressures exceeding the first range of pressures. Displacement of the tip is detected.

### SUMMARY OF THE INVENTION

According to an aspect of some embodiments of the present invention there is provided a variable capacitor sensor for sensing pressure applied on a stylus tip when pressed against a surface as when writing with the stylus. According to some embodiments of the present invention, the variable capacitor includes a first electrode that is embedded in a PCBA of the stylus and a second electrode that physically to contacts conductive pads on the PCBA for establishing electrical connection. According to some embodiments of the present invention, the second electrode is supported by an element that moves together with the stylus tip and deforms in response to a pressure applied on the tip.

An aspect of some embodiments of the present invention is the provision of a pressure sensor for sensing pressure on a tip of a stylus, the pressure sensor comprising a variable capacitor, a power supply, and a capacitance measuring unit. The variable capacitor includes a first electrode coated with solid dielectric layer, a second electrode formed at least in part with elastic material, and a support element that moves together with the tip of the stylus and presses against the second electrode in response to pressure applied on the tip. A portion of the dielectric layer is patterned with a conductive pad that is exposed and the second electrode contacts the conductive pad patterned on the dielectric layer. The power supply and the capacitance measuring unit establish electrical connection with the second electrode via the conductive pad.

Optionally, the first electrode is embedded in a PCBA and the conductive pad is patterned on a surface of the PCBA.

Optionally, the first electrode is patterned on a first layer of the PCBA and the dielectric layer is a second layer of the PCBA, which coats the first layer of the PCBA.

Optionally, the PCBA is fixed to a housing of the stylus.

Optionally, the second electrode is supported by the support element that that moves together with the tip of the stylus.

Optionally, the second electrode includes a base surface and at least one protruding element protruding from the base surface.

Optionally, the at least one protruding element contacts the conductive pad.

Optionally, the conductive pad is sized, shaped and positioned to match contact area provided by the at least one protruding element.

Optionally, the conductive pad is positioned with respect to the second electrode at a location where there is a defined air gap between the second electrode and the conductive pad when no pressure is applied on the tip.

Optionally, a surface area of the first electrode is defined to be larger than a surface area of the second electrode.

Optionally, the first electrode is formed from a plurality of discrete patterned areas that are electrically connected, and wherein the conductive pad is positioned to between the discrete patterned areas.

Optionally, the first electrode is formed from a circular area surrounded by a ring shaped area.

Optionally, the protruding element is ring shaped.

Optionally, a height of the protruding element is defined to correspond to a tip travel distance defined for switching from a hover operational state to a touch operational state.

Optionally, the base surface of the second electrode is defined to be curved or angled.

Optionally, the second electrode is formed from conductive rubber.

An aspect of some embodiments of the present invention is the provision of a pressure sensor for sensing pressure on a tip of a stylus, the pressure sensor including: a variable capacitor, a power supply; and a capacitance measuring unit. The variable capacitor includes: a first electrode coated with solid dielectric layer, wherein a portion of the dielectric layer is patterned with a conductive pad that is exposed; a second electrode formed at least in part with elastic material, wherein the second electrode contacts the conductive pad patterned on the dielectric layer after a defined threshold contact pressure is been applied on the tip of the stylus; and a support element that moves together with the tip of the stylus and presses against the second electrode in response to pressure applied on the tip. Wherein the power supply and the capacitance measuring unit establish electrical connection with the second electrode via the conductive pad.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example to only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic drawing of an exemplary assembly for a tip of a stylus integrated with a variable capacitor in accordance with some embodiments of the present invention;

FIG. 2 is a simplified schematic drawing of the exemplary variable capacitor in accordance with some embodiments of the present invention;

FIGS. 3A and 3B are simplified bottom views of two exemplary layers of a PCBA of the variable capacitor in accordance with some embodiments of the present invention;

FIGS. 4A and 4B are simplified top views of two exemplary deformable electrodes in accordance with some embodiments of the present invention;

FIGS. 5A, 5B and 5C are simplified schematic drawings showing exemplary deformations of the deformable electrodes for three different tip pressure levels in accordance with some embodiments of the present invention;

FIG. 6 is a simplified graph of a relationship between applied pressure on a tip of a stylus and capacitance of the variable capacitor, in accordance with some embodiments of the present invention;

FIG. 7 is a simplified schematic drawing of an exemplary assembly for a tip of a stylus integrated with a variable capacitor in accordance with some other embodiments of the present invention;

FIG. 8 is a simplified schematic drawing of the exemplary variable capacitor in accordance with some other embodiments of the present invention;

FIGS. 9A and 9B are simplified bottom views of two exemplary layers of a PCBA of the variable capacitor in accordance with some other embodiments of the present invention;

FIGS. 10A, 10B and 10C are simplified schematic drawings showing to exemplary deformations of the deformable electrodes for three different tip pressure levels in accordance with some other embodiments of the present invention;

FIG. 11 is a simplified graph of a relationship between applied pressure on a tip of a stylus and capacitance of the alternative variable capacitor, in accordance with some embodiments of the present invention;

FIG. 12 is a simplified block diagram of an exemplary pressure sensitive stylus in accordance with some embodiments of the present invention; and

FIG. 13 is a simplified block diagram of an exemplary digitizer system that is operated with a pressure sensitive stylus in accordance with some embodiments of the present invention.

### DESCRIPTION OF SPECIFIC EMBODIMENTS OF THE INVENTION

The present invention, in some embodiments thereof, relates to a pressure sensitive stylus and, more particularly, but not exclusively, to a sensor that senses transition between a hover and touch state of a stylus.

According to some embodiments of the present invention, the pressure sensitive stylus includes a variable capacitor sensor for sensing pressure applied on the stylus tip such as when writing with the stylus and/or pressing down on the stylus tip.

According to some embodiments of the present invention, the variable capacitor sensor is operative to sense transition between hover and touch operational states of the stylus, e.g. the sensor operates as a tip switch to determine when the stylus tip is pressed. Optionally, the variable capacitor sensor is also operative to sense and/or monitor varying pressure grades during a touch operational state of the stylus, e.g. change in pressure during writing, and/or to detect different pressures applied at different touch events.

According to some embodiments of the present invention, the first electrode is coated with a dielectric material that provides a defined dielectric separation between the pair of electrodes of the variable capacitor. According to some embodiments of the present invention, the PCBA including the first electrode is a multi-layer PCBA, and the first electrode is patterned on one of the internal layers of the PCBA, e.g. a layer not exposed to air. In some exemplary embodiments of the present invention, the first electrode is patterned on a layer internal to the outermost layer of the PCBA to and the dielectric material of the outermost layer of the PCBA operates as the solid dielectric material of the variable capacitors. Optionally, the same PCBA also includes an integrated circuit (IC) component, e.g. an application specific IC (ASIC) for controlling and operating the stylus and/or additional circuitry. Typically, the PCBA is positioned so that it is perpendicular to a longitudinal axis of the stylus.

According to some embodiments of the present invention, the second electrode includes one or more protruding portions, elements and/or parts, e.g. one or more balls and/or prongs facing the outer surface of the PCBA. According to some embodiments of the present invention, the second electrode is positioned so that at least the protruding part is in physical contact with the outer surface of the PCBA even while no pressure is applied on the stylus tip. According to some embodiments of the present invention, the protruding element separates a portion of the second electrode from PCBA surface so that the variable capacitor sensor includes a volume of air between the two electrodes while no pressure is applied on the stylus tip.

According to some embodiments of the present invention, a portion of the outermost layer of the PCBA that is in contact with the protruding part of the second electrode is patterned with conductive material for establishing electrical communication and/or connection between the second electrode and circuitry of the sensor, e.g. capacitive measurement unit and the power source. The present inventors have found that by establishing electrical connection for the second electrode as described herein, known difficulties in providing electrical connection between elements that move in relation to each other can be avoided.

Alternatively, a portion of the outermost layer of the PCBA that is distanced from this protruding part of the second electrode is patterned with conductive material for establishing electrical communication and/or connection between the second electrode and circuitry of the sensor. In yet other alternative exemplary embodiments, the distance between the second electrode and the PCBA during a neutral tip state is provided by one or more spring elements or other elastic elements positioned between the outer surface of the PCBA and one or more support elements that moves together with the tip of the stylus. Optionally, in these alternative embodiments, the second electrode is flat and/or doesn't include the one or more protruding portions for making the initial contact with the PCBA. In all these cases, electrical communication is established after pressure is applied to press the second electrode against the to conductive material on the PCBA. Typically, the pressure required to establish electrical communication corresponds to the threshold pressure used to switch between a hover and touch operational state.

According to some embodiments of the present invention, the second electrode is formed from deformable material that deforms as it is pressed against the outer layer of the PCBA. Typically, deformation of the second electrode in response to pressure applied on the stylus tip increases the contact area between the second electrode and the PCBA and reduces the volume of air between the pair of electrodes and/or between the second electrode and the PCBA. Typically, variation in the capacitance is due to the deformation of the second electrode and a change in the volume of air between the pair of electrodes due to the deformation and/or movement of the second electrode. Optionally, the first electrode spans a larger surface area as compared to the second electrode and deformation of the second electrode increases a surface area of the second electrode sot that an area of overlap between the first electrode and the second electrode is increased. Alternatively and/or additionally, the conductive material on the outer layer of the PCBA is a spring and/or elastic element that protrudes from the surface of the PCBA and is compressed and/or bends in response to applied pressure.

Optionally, the first electrode is formed from a plurality of conductive elements that are electrically connected. Optionally, separation between the plurality of conductive elements is matched with positioning of the conductive material on the outer most surface of the PCBA. Optionally, size and shape of the separation and/or the conductive material on the outermost surface of the PCBA are defined to reduce capacitive coupling between the first electrode and the conductive material on the outermost surface of the PCBA so that the initial and/or constant capacitance of the variable capacitor is relatively low.

Optionally, the second electrode is formed from a conductive rubber and/or silicone mixed with conductive particles. Typically, the sensitivity of the variable capacitor sensor at different tip pressures is defined by the properties and/or shape of the second electrode. In some exemplary embodiments, a shape of the second electrode is defined so that the contact area between the second electrode and the PCBA changes in a desired non-linear fashion in response to tip movement. Optionally height of the protruding element is defined to correspond to distance of tip to travel from a neutral position when no pressure is applied on the tip to a touch operational state, e.g. when a threshold amount of pressure is applied on the tip due to contact. Optionally, output is non-linear and provides for greater sensitivity around the transition between hover and touch.

In some exemplary embodiments, the second electrode eliminates the need for an additional spring or other elastic element typically used for providing a resilient force during tip movement. Optionally, the protruding element additionally provides a desired lower tip stiffness during hover as compared to touch. Optionally, additional portions of the second electrode are defined to be non-flat. According to some embodiments of the present invention, the variable capacitor sensor for sensing stylus tip movement as described herein provides advantages over the prior art due to its simple and robust construction. The present inventors have found that this ability to introduce a desired non-linear response to tip movement as described herein, with a single element, e.g. the second electrode, simplifies construction of the variable capacitor sensor, and improves tolerances and uniformity among different styluses defined to have a same construction.

Typically, the stylus transmits output from the variable capacitor sensor to an associated digitizer sensor and/or system by wireless communication.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Referring now to the drawings, FIG. 1 shows a simplified schematic drawing of an exemplary assembly for a tip of a stylus integrated with a variable capacitor in accordance with some embodiments of the present invention. According to some embodiments of the present invention, a stylus 200 includes a writing tip 360 that can slide in and out of housing 305 in response to pressure applied on writing tip 360. Typically, tip 360 has a range of motion in the order of magnitude of a few hundred μm, e.g. 100-500 μm. Typically, movement of tip 360 is initiated by contact pressure applied on tip 360 and is opposed by a resilient force provided by an elastic element 355. According to some embodiments of the present invention, tip 360 is coupled to a to variable capacitor 350 whose capacitance changes with movement of tip 360.

According to some embodiments of the present invention, variable capacitor 350 includes a first electrode 354 patterned on a substrate, e.g. PCBA 352 and a second electrode 355 that moves together with tip 360 and/or deforms in response to pressure applied on tip 360. According to some embodiments of the present invention, variable capacitor 350 varies in response to movement and/or deformation of second electrode 355. Typically substrate 352 is fixed to a housing 305 of stylus 200 and is stationary with respect to sliding movement of tip 360. Typically, PCBA 352 is electrically connected to circuitry and/or a power source included in stylus 200 from which first electrode 354 is charged. Typically, PCBA 352 is positioned to face second electrode 355.

Optionally, second electrode 355 is supported by a shaft 361, e.g. a tip holder that is physically connected to tip 360, e.g. fixed to tip 360. Typically, shaft 361 is formed from non-conductive material. Alternatively, second electrode 355 is directly supported by tip 360. According to some embodiments of the present invention, second electrode 355 is formed with conductive material that is elastic, e.g. conductive rubber, so that it deforms when pressed, e.g. by shaft 361 of tip 360. Typically, deformation of second electrode 355 alters the capacitance of variable capacitor 350.

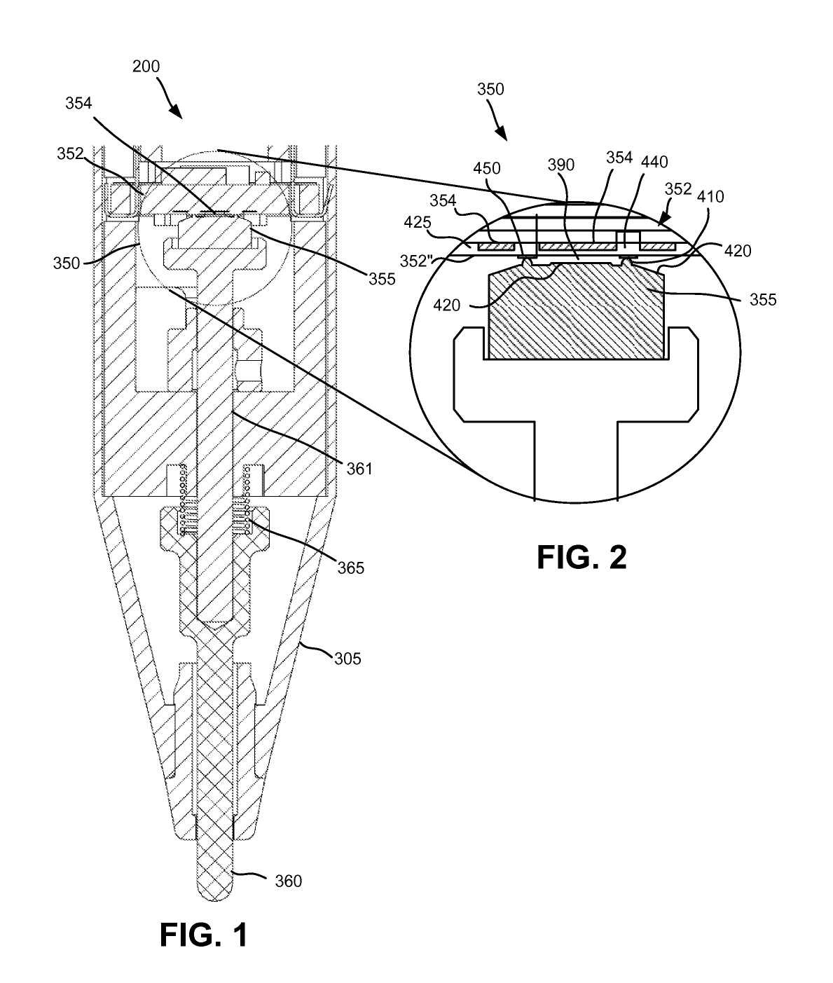

Reference is now also made to FIG. 2 showing a simplified schematic drawing of the exemplary variable capacitor in accordance with some embodiments of the present invention. According to some embodiments of the present invention, both first electrode 354 and second electrode 355 are electrically connected to circuitry and/or the power source of stylus 200 via PCBA 352. According to some embodiments of the present invention, first electrode 354 is embedded in PCBA 352 and the second electrode 355 is electrically connected to PCBA 352 by maintaining physical contact with conductive pad(s) and/or strip(s) 450 patterned on an outer layer 352″ of PCBA 352.

According to some embodiments of the present invention, a dielectric material separates first electrode 354 and second electrode 355. Typically, PCBA 352 is a multilayer PCBA and first electrode 354 is patterned on an inner layer of PCBA 352, e.g. a layer that is not exposed. In some exemplary embodiments, the dielectric material of variable capacitor 350 is and/or includes a dielectric layer 425 of PCBA. According to some embodiments of the present invention, variable capacitor 350 to includes an additional dielectric layer formed from a volume of air 390 between second electrode 355 and PCBA 352. Optionally, dielectric layer 425 is made of FR-4 glass epoxy typically used in PCBs. Optionally, higher dielectric coefficient materials are applied on the PCBA.

In some exemplary embodiments, first electrode 354 is formed from a plurality of parts that are electrically connected, and conductive pad(s) 450 is positioned and/or aligned with a break 440 in a pattern of first electrode 354, e.g. a space between the plurality of parts of first electrode 354. Typically, conductive pads 450 and first electrode 354 are shaped and sized to reduce capacitive coupling between pads 450 and first electrode 354.

According to some embodiments of the present invention, second electrode 355 includes one or more protruding elements 410 that protrude from a base surface 420 of second electrode 355 that faces PCBA 352. Typically, the protruding element(s) 410 is positioned to match position of conductive pad(s) 450. According to some embodiments of the present invention, protruding element(s) 410 of second electrode physically contact conductive pad(s) 450 during a neutral state of tip 360, e.g. when no contact pressure is applied on the tip. Optionally, second electrode 355 is preloaded with a defined preload force, e.g. 1-10 gm, so that contact between protruding element(s) 410 and conductive pad(s) 450 is maintained at all times. Alternatively, protruding element(s) 410 of second electrode 355 is positioned to be spaced away from conductive pad(s) 450 during a neutral state of tip 360, e.g. when no contact pressure is applied on the tip.

According to some embodiments of the present invention, as tip 360 recedes into housing 305 due to contact pressure, second electrode 355 begins to deform and/or flatten against PCBA 352 and an air gap 390 between elastic component 355 and PCBA 352 (present during a neutral state of tip 360) diminishes. Typically, changes in dimensions of air gap 390 as well as changes in shape of second electrode 355 affect changes in capacitance of variable capacitor 350. In some exemplary embodiments, as second electrode 355 is compressed, an effective surface area of electrode 355 is increased and an overlapping area between first electrode 354 and second electrode 355 also increases. Typically, both these occurrences affect changes in capacitance of variable capacitor 350. In some exemplary embodiments, surface 420 is a curved surface or a surface that has a non-linear contour so that portions of to surface 420 that flatten against PCBA 352 increase in a non-linear manner as tip 306 recedes into housing 305. Optionally, a peripheral portion of surface 420 is angled with respect to a central portion of surface 420.

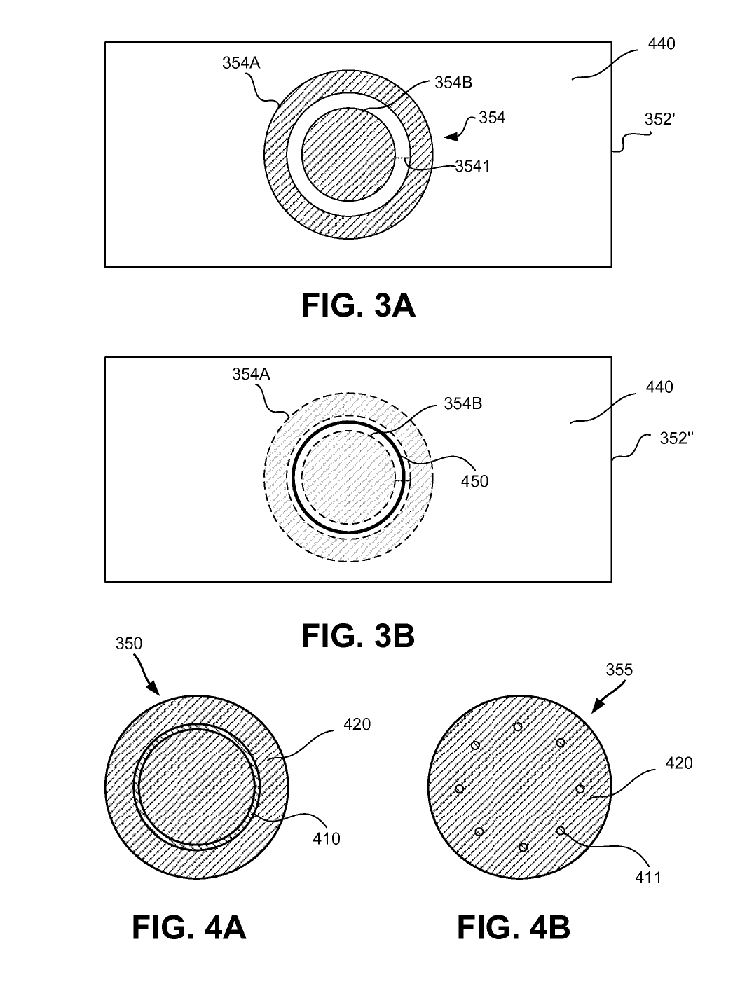

Reference is now made to FIGS. 3A and 3B showing simplified bottom views of two exemplary layers of a PCBA of the variable capacitor in accordance with some embodiments of the present invention. According to some embodiments of the present invention, first electrode 354 is patterned on a layer 352′ of PCBA 352 and is formed from an inner circular shaped element 354B and a surrounding ring shaped element 354A. Optionally, circular shaped element 354B and ring shaped 354A element are electrically connected with a connection 3541 formed on an inner more layer of PCBA 354. It is noted that the design including inner circular shaped element 354B and surrounding ring shaped element 354A is only exemplary and the first electrode 354 can alternatively have other shapes and/or can be formed from a single element. It is also noted that although PCBA 352 is shown to have a rectangular shape, PCBA 352 can alternatively have another shape, e.g. square or circular shape. According to some embodiments of the present invention, layer 352′ is coated with an outermost layer 352″ that is patterned with conductive pad 450. In some exemplary embodiments, conductive pad 450 is ring shaped and is aligned between elements 354A and 354B. Alternatively, conductive pad 450 is formed from a plurality of elements that are optionally electrically connected. Optionally, conductive pad 450 is patterned to be flat with respect to the surface of layer 352″. Typically, both first conductive element 354 and conductive pad 450 are connected to circuitry and/or a power source line on other layers of PCBA 352.

Reference is now made to FIGS. 4A and 4B showing simplified top views of two exemplary deformable electrodes in accordance with some embodiments of the present invention. According to some embodiments of the present invention, second electrode 355 is cylindrically shaped with a circular cross section. Alternatively, second electrode 355 may have a rectangular or oval cross section. In some exemplary embodiments, protruding element 410 is ring shaped and positioned to match positioning of conductive pad 450 which is optionally ring shaped. In some exemplary embodiments, surface 420 is curved and/or otherwise not flat. Alternatively, second electrode 355 includes a plurality of protruding elements 411, to e.g. prongs and/or semi-sphere shaped elements. Optionally, second electrode 410 includes a plurality of protruding elements that have different heights, which may provide for any required pressure function.

Typically, second electrode 355 is formed from conductive rubber or the like. In some exemplary embodiments, second electrode 355 is formed from elastomer with conductive filler and/or additive and/or silicone rubber. Optionally, second electrode 355 is defined to have a hardness that provides 0-250 μm displacement of the tip in response to a 0-0.35 kg force applied on the tip. Optionally, second electrode 355 is defined to have a hardness of 20-85 durameter (hardness) Shore A. Optionally, the properties of protruding element 410 are defined to be different than that of the rest of second electrode 355. Typically, the height, size, shape and material of protruding element 410 are defined to obtain a desired relationship between tip movement of stylus tip 360 and capacitance gradient over the hover range. Typically, the size and shape of base surface 420 as well as the material of second electrode 355 are defined to obtain a desired relationship between tip movement of stylus tip 360 and capacitance gradient over a touch range.

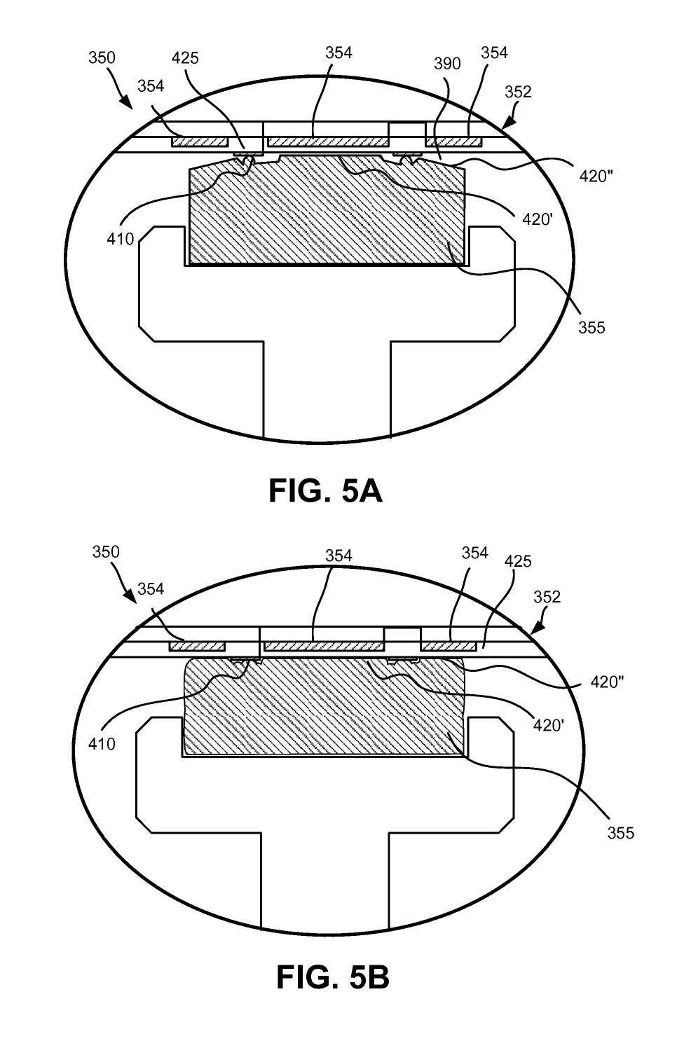

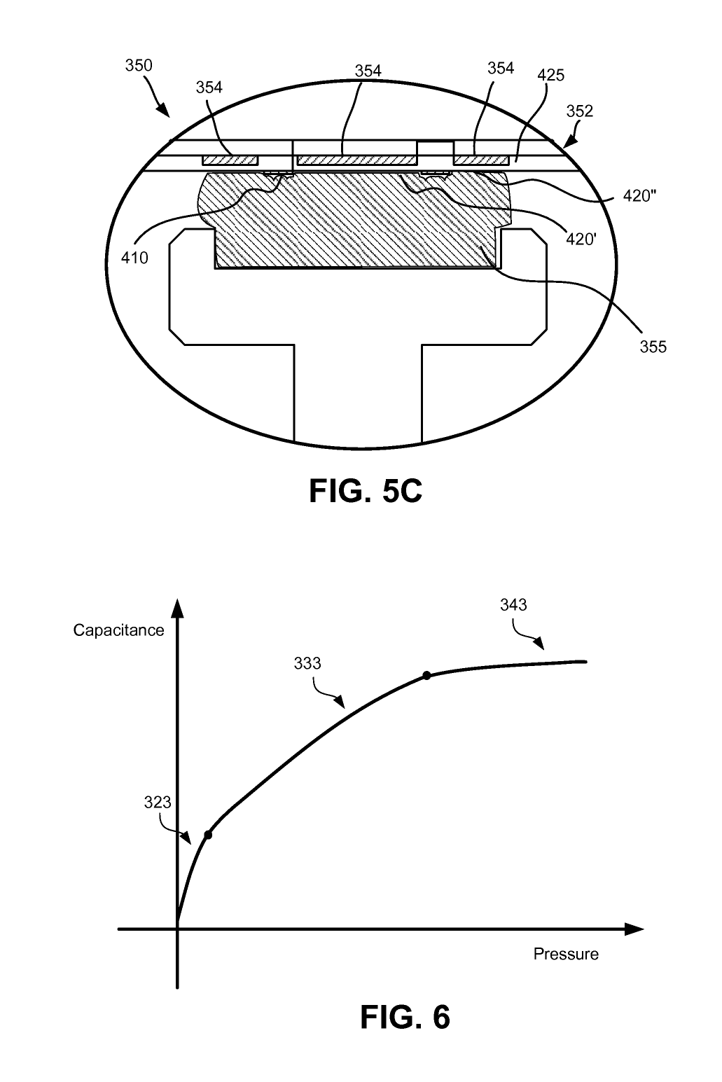

Reference is now made to FIGS. 5A and 5B showing exemplary deformations of the deformable electrodes for two different tip pressure levels and to FIG. 6 showing a simplified graph of a relationship between applied pressure on a tip of a stylus and capacitance of the variable capacitor, all in accordance with some embodiments of the present invention. Referring now to FIG. 5A showing an exemplary deformation of second electrode 355 at a transition between a hover and touch operational state. According to some embodiments of the present invention, second electrode 355 is shaped and its properties defined so that around a transition between hover and touch the protruding element 410 recedes due to applied pressure and additional portions of surface 420, e.g. portion 420′ come into contact with PCBA 352. Optionally, other portions of surface 420, e.g. portion 420″ are distanced from PCBA 352 at this transition distance. Typically, when portion 420′ is pressed against PCBA 352, the capacitance as well as the gradient change in capacitance of variable capacitor 350 is significantly increased due to elimination of the air layer 390 between portion 420′ and PCBA 352. Typically, the sharp increase in capacitance occurs due to the reduced distance between PCBA 352 and second portion 420′, and to the dielectric layer of variable capacitor 350 switching from being double dielectric layer to (including both solid layer 425 and air layer 390) to a single dielectric layer formed from solid layer 425. An exemplary increase in capacitance during this period can be seen for example in section 323 in FIG. 6. In some exemplary embodiments, the surface area of protruding element 410 is significantly smaller than an overall surface area of surface 420 so that the pressure required to reach tip travel distance to transition between hover and touch can be relatively low while the sensitivity of the variable capacitor sensor at the transition state can be relatively high.

Referring now to FIG. 5B showing an exemplary deformation of second electrode 355 during a touch operational state of the stylus tip. Typically, as additional pressure is applied on tip 360, second electrode 355 is further compressed against PCBA 352 and most and/or all of the air layer between PCBA 352 and second electrode 355 is expelled. Typically, the stiffness of the second electrode between transition and maximum pressure is significantly larger than the stiffness between neutral tip position and the transition between hover to touch due to the large surface area that makes contact with PCBA 352. Typically, the capacitance continues to increase during this period in response to applied pressure as shown for example in section 333 in FIG. 6. Typically the capacitance changes at a slower rate as compared to the change in section 323.

Referring now to FIG. 5C showing an exemplary deformation of second electrode 355 at maximum or near maximum pressure. According to some embodiments of the present invention, as additional pressure is applied, second electrode is further deformed so that the effective surface area 420″ widens, e.g. the diameter increases and more overlap is established with first electrode 354. Typically, the increase in the effective surface area during this period further increases the capacitance of variable capacitor 350. Optionally, maximum pressure is achieved at a maximum diameter of second electrode 355. Typically, the capacitance increases during this period as shown for example in section 343 in FIG. 6. Typically, the capacitance changes at a lower rate as compared to the changes in sections 323 and 333.

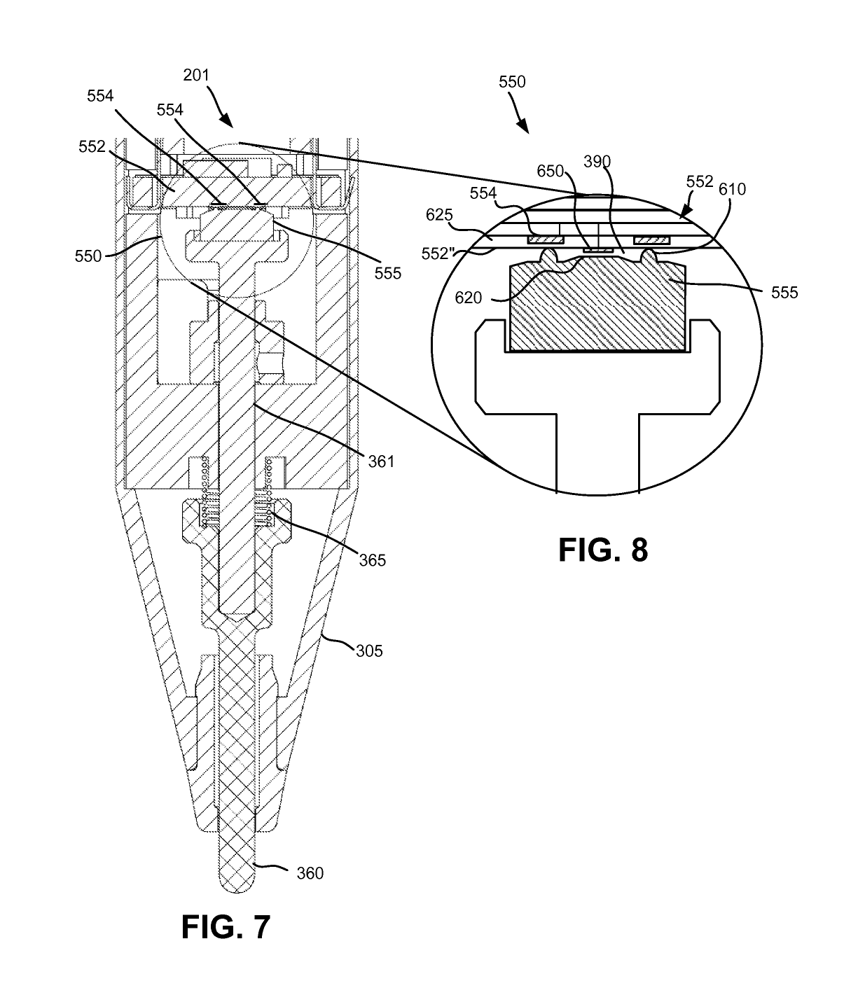

Reference is now made to FIGS. 7-12 describing features of the variable capacitor in accordance with some other embodiments of the present invention. According to some embodiments of the present invention, the second electrode of the variable capacitor is designed to be disconnected from circuitry of the sensor, e.g. capacitive measurement unit and the power source over a first range of pressures applied on the tip and connected to the circuitry after a threshold level of pressure has been reached. Typically, the pressure required to establish electrical connection is defined to correspond to the pressure required to switch from a hover operational state to a touch operational state. The present inventors have found that the variable capacitor sensor in these embodiments may respond faster to a change in the operational state of the stylus and/or the switching between operational states may be more clearly detected.

Reference is now made to FIG. 7 showing a simplified schematic drawing of an exemplary assembly for a tip of a stylus integrated with a variable capacitor in accordance with some other embodiments of the present invention. As described in reference to FIG. 1, movement of tip 360 is typically initiated by contact pressure applied on tip 360 and is opposed by a resilient force provided by an elastic element. According to some embodiments of the present invention, the elastic element is the second electrode 355 of variable capacitor 550. According to some embodiments of the present invention, tip 360 is coupled to a variable capacitor 550 whose capacitance changes with movement of tip 360.

According to some embodiments of the present invention, variable capacitor 550 includes a first electrode 554 patterned on a substrate, e.g. PCBA 552 and second electrode 355 that moves together with tip 360 and/or deforms in response to pressure applied on tip 360. According to some embodiments of the present invention, variable capacitor 550 is activated for pressures above a pre-defined pressure threshold and varies in response to movement and/or deformation of second electrode 355. Below the pre-defined pressure threshold, capacitor 550 is typically not active. Typically substrate 552 is fixed to a housing 305 of stylus 201 and is stationary with respect to sliding movement of tip 360. Typically, PCBA 552 is electrically connected to circuitry and/or a power source included in stylus 201 from which first electrode 554 is charged. Typically, PCBA 552 is positioned to face second electrode 355. Optionally, second electrode 355 is supported by a shaft 361, e.g. a tip holder that is physically connected to tip 360, e.g. fixed to tip 360. Typically, shaft 361 is formed from non-conductive material. Alternatively, second electrode 355 is directly supported by tip 360. According to some embodiments of the present invention, second electrode 355 is formed with conductive material that is elastic, e.g. conductive to rubber, so that it deforms when pressed, e.g. by shaft 361 of tip 360. Typically, deformation of second electrode 355 alters the capacitance of variable capacitor 550. Typically, variable capacitor 550 is activated once a pre-defined initial pressure is applied on tip 360 and/or second electrode 355.

Reference is now made to FIG. 8 showing a simplified schematic drawing of the exemplary variable capacitor in accordance with some other embodiments of the present invention. According to some embodiments of the present invention, first electrode 554 is embedded in PCBA 552 and protruding elements 410 of second electrode 355 is positioned to be in physical contact with PCBA 552. Optionally, second electrode 355 is preloaded with a defined preload force, e.g. 1-10 gm, so that contact between protruding element(s) 410 and PCBA 552 is maintained at all times. According to some embodiments of the present invention, PCBA 552 includes a conductive pad and/or strip 650 patterned on an outer layer 552″ of PCBA 552. Typically, conductive pad 650 is positioned at a location at which there is an air gap 390 between PCBA 552 and second electrode 355. Typically, second electrode 355 is shaped and sized to provide defined air gap 390 while protruding elements 410 is in physical contact with PCBA 552 and no contact pressure is applied on tip 360. Typically, protruding element(s) 410 of second electrode 355 is positioned to be spaced away from conductive pad 650. Typically, conductive pad 650 and first electrode 554 are shaped and sized to reduce capacitive coupling between pads 650 and first electrode 554.

Typically, PCBA 552 is a multilayer PCBA and first electrode 554 is patterned on an inner layer of PCBA 552, e.g. a layer that is not exposed. According to some embodiments of the present invention, a dielectric material separates first electrode 554 and second electrode 355 in the vicinity of protruding elements 410. In some exemplary embodiments, the dielectric material of variable capacitor 550 is and/or includes a dielectric layer 625 of PCBA. Optionally, dielectric layer 425 is made of FR-4 glass epoxy typically used in PCBs. Optionally, higher dielectric coefficient materials are applied on the PCBA. According to some embodiments of the present invention, variable capacitor 550 includes an additional dielectric layer formed from volume of air gap 390 between second electrode 355 and PCBA 552.

According to some embodiments of the present invention, as tip 360 recedes into housing 305 due to contact pressure, second electrode 355 begins to deform and/or flatten against conductive pad 650 and electrical contact between second electrode 355 and sensor circuitry on PCBA 552 is established. Typically, capacitance levels are detected once electrical contact is established. Typically, as tip 360 continues to recedes into housing 305 due to additional contact pressure, air gap 390 around conductive pad 650 diminishes and the capacitance level increases further.

Typically, changes in dimensions of air gap 390 as well as changes in shape of second electrode 355 affect changes in capacitance of variable capacitor 550. In some exemplary embodiments, as second electrode 355 is compressed, an effective surface area of second electrode 355 is increased and an overlapping area between first electrode 554 and second electrode 355 also increases. Typically, both these occurrences affect changes in capacitance of variable capacitor 550. In some exemplary embodiments, surface of second electrode 355 has a non-linear contour so that portions of the surface that flatten against PCBA 552 increase in a non-linear manner as tip 306 recedes into housing 305.

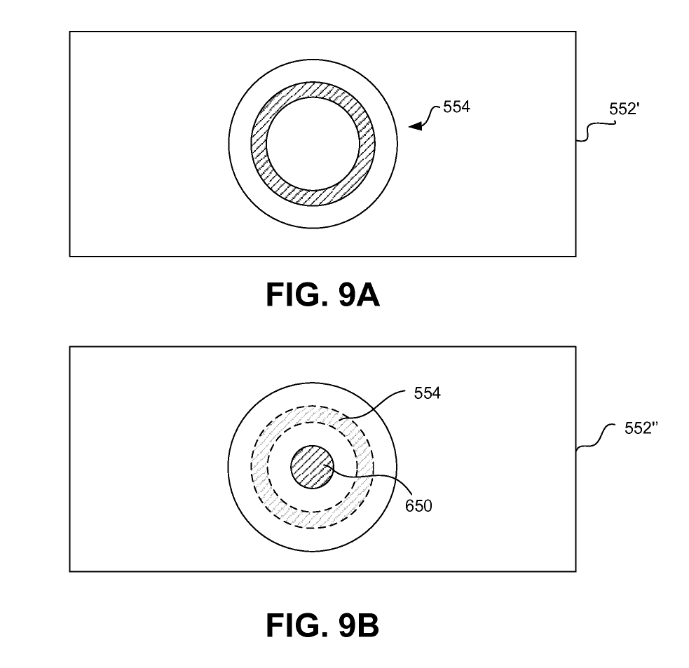

Reference is now made to FIGS. 9A and 9B showing simplified bottom views of two exemplary layers of a PCBA of the variable capacitor in accordance with some other embodiments of the present invention. According to some embodiments of the present invention, first electrode 554 is patterned on a layer 552′ of PCBA 552. Optionally, first electrode is ring shaped. According to some embodiments of the present invention, layer 552′ is coated with an outermost layer 552″ that is patterned with conductive pad 650. In some exemplary embodiments, conductive pad 650 is circular shaped and is centered with respect to first electrode 554. Optionally, conductive pad 450 is patterned to be flat with respect to the surface of layer 552″. Typically, both first electrode 554 and conductive pad 650 are connected to circuitry and/or a power source line on other layers of PCBA 552.

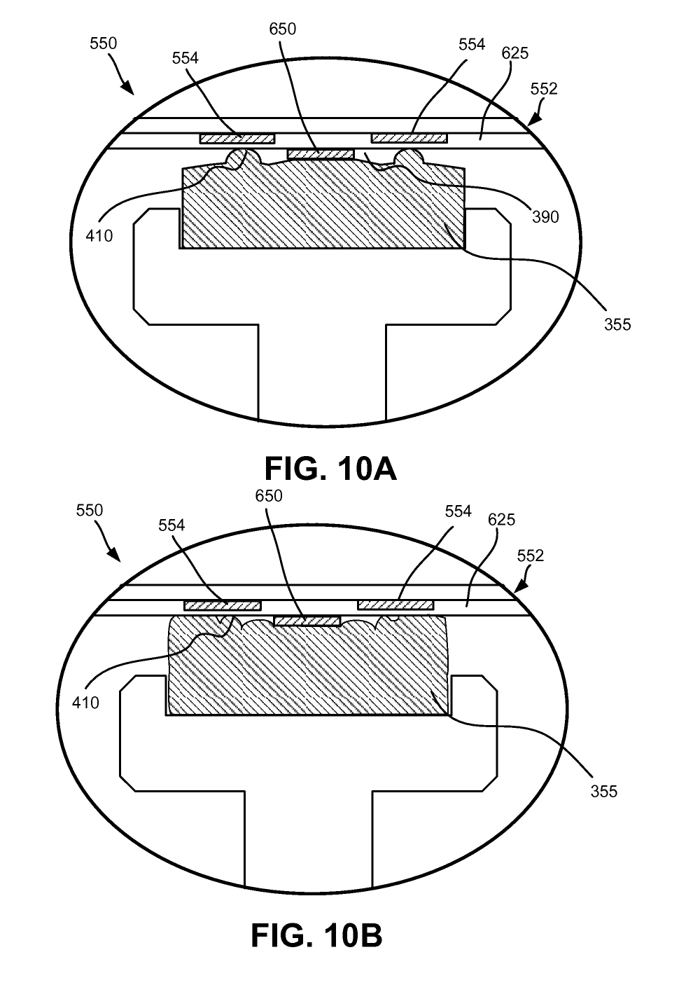

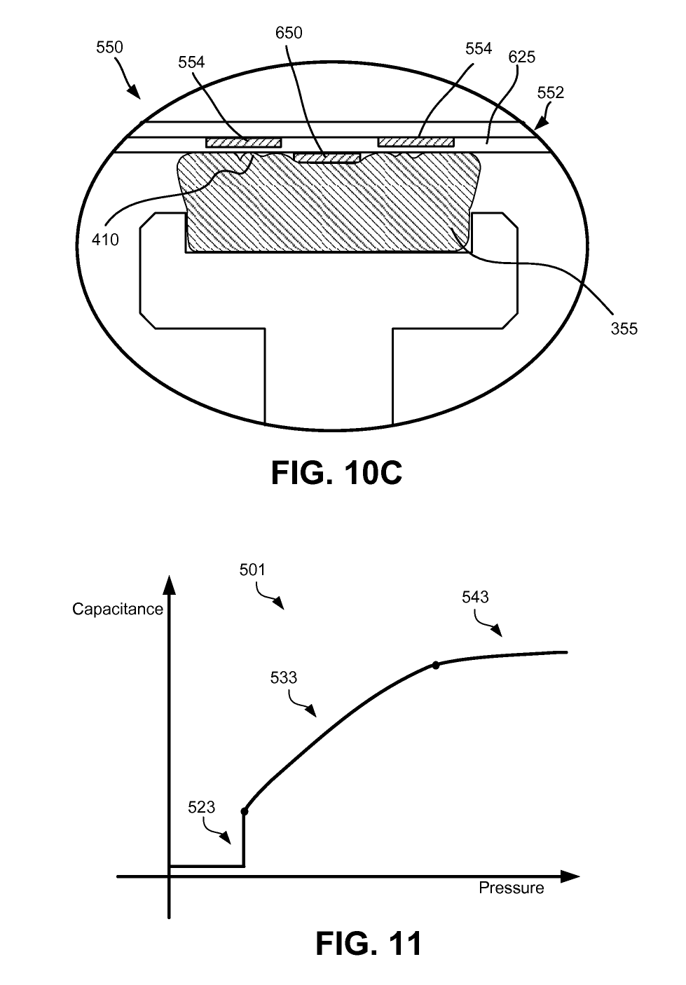

Reference is now made to FIGS. 10A, 10B and 10C showing a simplified schematic drawing showing exemplary deformations of an elastic component of the variable capacitor in accordance with some other embodiments of the present invention. According to some embodiments of the present invention, second electrode 355 with protruding elements 410 are shaped and its properties defined so that around a transition between hover and touch, a portion of second electrode 355 makes contact with conductive pad 650 (FIG. 10A). Typically, in response to established contact, to second electrode 355 is electrified and capacitance is detected by variable capacitor 550. Typically, the capacitance detected by variable capacitor 550 at the onset of contact with conductive pad 650 changes sharply from no or little capacitance to a significant level of capacitance. According to some embodiments of the present invention, as more pressure is applied (FIG. 10B and subsequently FIG. 10C), additional portions of second electrode 355 flatten against PCBA 552 so that an effective surface area of second electrode 355 widens, e.g. the diameter increases and more overlap is established with first electrode 554. Typically, as second electrode 355 flattens, air gap 390 diminishes and/or disappears. Typically, the increase in the effective surface area and the decrease in air gap 390 increase the capacitance of variable capacitor 550.

Reference is now made to FIG. 11 showing a simplified graph of a relationship between applied pressure on a tip of a stylus and capacitance of the variable capacitor, in accordance with some other embodiments of the present invention. According to some embodiments of the present invention, no capacitance is measured over a first range of pressures as shown in section 523 of the capacitance graph 5-1. Typically, this range of pressure corresponds to the pressures applied on tip 360 prior to establishing contact between second electrode 355 and conductive pad 650. Typically, pressures 523 are associated with a hover operational state.

According to some embodiments of the present invention, capacitance 501 increases sharply over a narrow range of pressures when contact is first established between second electrode 355 and conductive 650 as shown in section 533. Typically, as the pressure increases, second electrode 355 flattens against PCBA 552 so that an effective surface area of second electrode 355 widens, e.g. the diameter increases and more overlap is established with first electrode 554. Typically, the increase in the effective surface area increases the capacitance of variable capacitor 550 as shown in section 543.

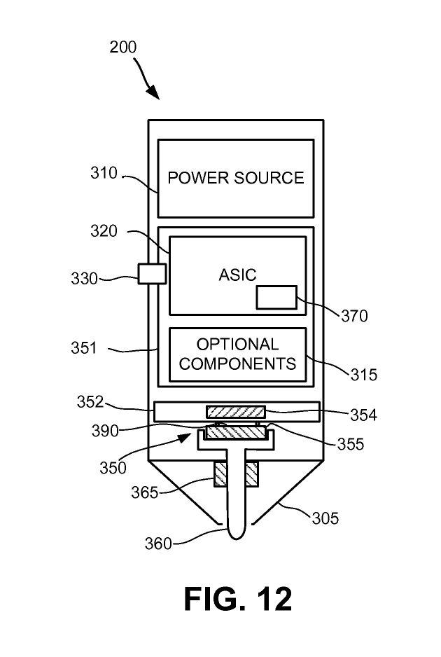

Reference is now made to FIG. 12 showing a simplified block diagram of an exemplary pressure sensitive stylus in accordance with some embodiments of the present invention. According to some embodiments of the present invention, stylus 200 includes a power source 310, e.g. one or more rechargeable batteries and/or super capacitors, a first PCBA assembly 351 including ASIC 320, one or more user controlled buttons 330, optional components 315, e.g. sensors, and second PCBA assembly 352 including components of a variable capacitor 350 for sensing pressure on the tip (and/or tip displacement). Typically, first PCBA assembly 351 and second PCBA assembly 352 are positioned substantially perpendicular to one another and are electrically connected. Alternatively, only one PCBA assembly that includes both ASIC 320 and first electrode 354 is used.

Typically variable capacitor 350 includes a first electrode 354 embedded in a PCBA 352 and second electrode 355 that faces PCBA 352 and is in physical contact with PCBA 352 but also moves with tip 360. Typically, second electrode 355 compresses or decompresses in response to movement of tip 360. Typically, variable capacitor 350 and 550 changes its capacitance as a function of tip displacement, e.g. as tip 360 recedes into and/or extends out of housing 305. Typically, tip 360 moves against an elastic force provided by second electrode 355 pressed against PCBA 352 and/or other elastic component 365 associated with tip 360.

According to some embodiments of the present invention, ASIC 320 controls charging first electrode 354 and second electrode 355 for operation of variable capacitor 350 and also detects capacitance of variable capacitor 350. In some exemplary embodiments, variable capacitor 350 is connected to a capacitive measurement unit 370 that is typically embedded in ASIC 320. Typically, variable capacitor 350 and capacitive measurement unit 370 together form the variable capacitor sensor. Optionally, the capacitive measurement unit 370 is an off-the-shelf unit, e.g. charge amplifier provided on the stylus electronics, e.g. ASIC or electronic circuit. Capacitive measurement unit 370 determines the capacitance value of the variable capacitor in accordance with methods known in the art, e.g. by examining the charge time and/or discharge time of the capacitor. In an exemplary embodiment, capacitive measurement unit 370 is capable of detecting ΔC of 1-10 pF, e.g. 4 pF.

According to some embodiments of the present invention, output from variable capacitor sensor 350 and/or capacitive measurement unit 370 is digitally encoded, e.g. by ASIC 320. Typically, ASIC 320 is also operative to produce and modulate a signal to be transmitted by stylus 200. Optionally, the signal is modulated to include information obtained from the variable capacitive sensor, as well as state of button(s) 330, stylus ID, battery health status, information from other sensors embedded within or communicating with the stylus and/or other information. In to some exemplary embodiments the information transmitted is pressure level as detected by the variable capacitor sensor. Optionally, the information transmitted is one of a hover or touch state as detected by variable capacitor sensor.

In some exemplary embodiments, tip 360 is at least partially conductive and is used as transmitting and/or transceiving antenna of stylus 200. Optionally, stylus 200 includes a resonance circuit used for transmitting the signal of the stylus. Optionally, changes in capacitance of variable capacitor 350 change frequency or another characteristic of the resonance circuit and/or of the signal transmitted by the stylus. It is noted that although FIG. 12 has been described in reference to variable capacitor 350, a same or similar block diagram can be applied to variable capacitor 550.

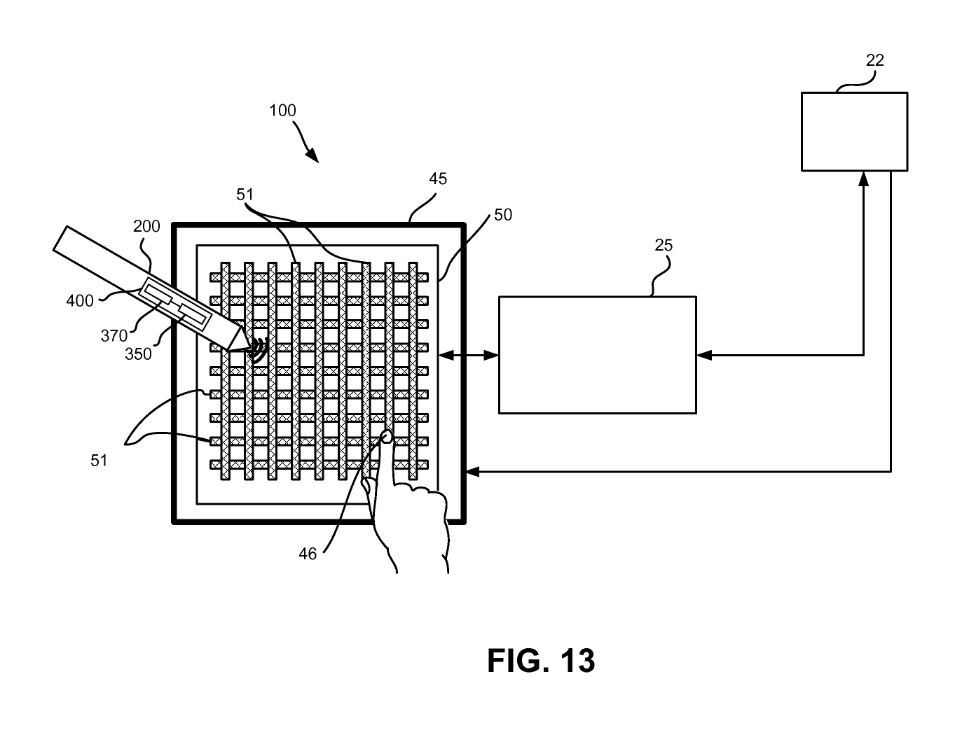

Reference is now made to FIG. 13 showing a simplified block diagram of an exemplary digitizer system that is operated with a pressure sensitive stylus in accordance with some embodiments of the present invention. According to some embodiments of the present invention, a computing device 100 includes a display screen 45 that is integrated with a digitizer sensor 50. In some exemplary embodiments, digitizer sensor 50 is a grid based capacitive sensor formed from conductive strips 51 that are operative to detect both input by pressure sensitive stylus 200 transmitting a signal and input by one or more fingertips 46 or other conductive objects. According to some embodiments of the present invention, pressure applied on a tip of stylus 200 and/or stylus 201 is sensed with a variable capacitor sensor 400 included in stylus 200. Typically, the variable capacitive sensor 400 includes at least one variable capacitor 350 and a capacitive measurement unit 370 or an equivalent component for assessing the applied pressure or the capacitance. In some exemplary embodiments, output from the variable capacitor sensor is transmitted by stylus 200 and picked up by one or more conductive lines 51. Optionally, output from variable capacitor sensor 400 is encoded in a position signal transmitted by stylus 200. Optionally, information indicating a touch or hover operational state, as detected by the variable capacitor sensor, is encoded in the position signal transmitted by stylus 200. Optionally, output from the variable capacitor sensor is transmitted in response to a query signal transmitted by digitizer system 100. Optionally, variable capacitor 350 senses or detects a touch operational state and in response stylus 200 begins to transmit a position signal. Optionally, stylus 200 continues to transmit a signal for the duration of the touch operational state and for a pre-defined period after the touch operational state is terminated. Optionally, stylus 200 transmits signal bursts both during a touch operational state and a hover operational state, however a transmission repeat rate during a hover operational state is reduced.

According to some embodiments of the present invention, a mutual capacitance detection method and/or a self-capacitance detection method are applied for sensing input from fingertip 46. Typically, during mutual capacitance and self-capacitance detection, digitizer circuitry 25 is required to send a triggering pulse and/or interrogation signal to one or more conductive strips 51 of digitizer sensor 50 and to sample output from the conductive strips in response to the triggering and/or interrogation. In some embodiments, some or all of conductive strips 51 along one axis of the grid based sensor are interrogated simultaneously or in a consecutive manner, and in response to each interrogation, outputs from conductive strips 51 on the other axis are sampled. This scanning procedure provides for obtaining output associated with each junction of the grid based sensor 50. Typically, this procedure provides for detecting one or more conductive objects, e.g. fingertip 46 touching and/or hovering over sensor 50 at the same time (multi-touch).

Typically, output from digitizer circuitry 25 is reported to host 22. Typically, the output provided by digitizer circuitry 25 includes coordinates of stylus 200, a pressure state or level of a tip of stylus 200 and/or coordinates of one or more fingertips 46 interacting with digitizer sensor 50. Optionally, digitizer circuitry 25 reports a hover or touch state for stylus 200. Optionally, digitizer circuitry 25 reports pressure applied on the stylus tip. Optionally, digitizer circuitry 25 additionally reports a hover or touch state for fingertip(s) 46. Typically, digitizer circuitry 25 uses both analog and digital processing to process signals and/or data picked up from sensor 50. Optionally, some and/or all of the functionality of digitizer circuitry 25 are integrated and/or included in host 22.

Digitizer systems that are similar to digitizer system 100 with digitizer circuitry 25 are described with further details, for example in U.S. Pat. No. 6,690,156 entitled “Physical object location apparatus and method and a graphical display device using the same,” U.S. Pat. No. 7,372,455 entitled “Touch Detection for a Digitizer,” U.S. Pat. No. 7,292,229 entitled “Transparent Digitiser,” U.S. Pat. No. 8,481,872, entitled “Digitizer, Stylus and Method of Synchronization Therewith,” the contents of all these patents are incorporated herein by reference.

Optionally, digitizer sensor 50 is alternatively an in-cell, on-cell, out-cell, transparent sensor or any other non-capacitive sensor technology, including but not limited to resistive, IR, ultrasonic, optical, or the like.

The terms “comprises”, “comprising”, “includes”, “including”, “having” and their conjugates mean “including but not limited to”.

The term “consisting of” means “including and limited to”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A pressure sensor for sensing pressure on a tip of a stylus, the pressure sensor comprising:
a variable capacitor comprising:
a first electrode coated with solid dielectric layer, wherein a portion of the dielectric layer is patterned with a conductive pad that is exposed;
a second electrode formed at least in part with elastic material,
wherein the second electrode contacts the conductive pad patterned on the dielectric layer; and
a support element that moves together with the tip of the stylus and presses against the second electrode in response to pressure applied on the tip;
a power supply; and
a capacitance measuring unit,
wherein the power supply and the capacitance measuring unit establish electrical connection with the second electrode via the conductive pad.

2. The pressure sensor of claim 1, wherein the first electrode is embedded in a PCBA and the conductive pad is patterned on a surface of the PCBA.

3. The pressure sensor of claim 2, wherein the first electrode is patterned on a first layer of the PCBA and the dielectric layer is a second layer of the PCBA, which coats the first layer of the PCBA.

4. The pressure sensor of claim 1, wherein the PCBA is fixed to a housing of the stylus.

5. The pressure sensor of claim 1, wherein the second electrode is supported by the support element that that moves together with the tip of the stylus.

6. The pressure sensor of claim 1, wherein the second electrode includes a base surface and at least one protruding element protruding from the base surface.

7. The pressure sensor of claim 6, wherein the at least one protruding element contacts the conductive pad.

8. The pressure sensor of claim 6, wherein the conductive pad is sized, shaped and positioned to match contact area provided by the at least one protruding element.

9. The pressure sensor of claim 1, wherein the conductive pad is positioned with respect to the second electrode at a location where there is a defined air gap between the second electrode and the conductive pad when no pressure is applied on the tip.

10. The pressure sensor of claim 1, wherein a surface area of the first electrode is defined to be larger than a surface area of the second electrode.

11. The pressure sensor of claim 1, wherein the first electrode is formed from a plurality of discrete patterned areas that are electrically connected, and wherein the conductive pad is positioned between the discrete patterned areas.

12. The pressure sensor of claim 11, wherein the first electrode is formed from a circular area surrounded by a ring shaped area.

13. The pressure sensor of claim 8, wherein the protruding element is ring shaped.

14. The pressure sensor of claim 6, wherein a height of the protruding element is defined to correspond to a tip travel distance defined for switching from a hover operational state to a touch operational state.

15. The pressure sensor of claim 1, wherein the base surface of the second electrode is defined to be curved or angled.

16. The pressure sensor of claim 1, wherein the second electrode is formed from conductive rubber.

17. A pressure sensor for sensing pressure on a tip of a stylus, the pressure sensor comprising:
a variable capacitor comprising:
a first electrode coated with solid dielectric layer, wherein a portion of the dielectric layer is patterned with a conductive pad that is exposed;
a second electrode formed at least in part with elastic material,
wherein the second electrode contacts the conductive pad patterned on the dielectric layer after a defined threshold contact pressure is been applied on the tip of the stylus; and
a support element that moves together with the tip of the stylus and presses against the second electrode in response to pressure applied on the tip;
a power supply; and
a capacitance measuring unit,
wherein the power supply and the capacitance measuring unit establish electrical connection with the second electrode via the conductive pad.
